(19) United States
(12) Patent Application Publication
(10) Pub. No.: US 2011/0113880 A1
(43) Pub. Date: May 19, 2011

(54) MICROMECHANICAL ACCELERATION SENSOR

(75) Inventors: Bernhard Schmid, Friedberg (DE); Roland Hilser, Kirchheim Teck (DE)

(73) Assignee: Continental Teves Ag & Co. oHG, Frankfurt (DE)

(21) Appl. No.: 12/992,401

(22) PCT Filed: May 15, 2009
(86) PCT No.: PCT/EP2009/055942

§ 371 Date: Dec. 28, 2010

(30) Foreign Application Priority Data
May 15, 2008 (DE) 10 2008 023 664.0

(51) Int. Cl. G01P 15/02

(52) U.S. Cl. 73/514.01

(57) ABSTRACT

A micromechanical acceleration sensor includes at least a first seismic mass which is suspended in a deflectable manner, at least one readout device for detecting the deflection of the first seismic mass and at least one resetting device.

### CROSS REFERENCE TO RELATED APPLICATIONS

This application is the U.S. national phase application of PCT International Application No. PCT/EP2009/055942, filed May 15, 2009, which claims priority to German Patent Application No. DE 10 2008 023 664.0, filed May 15, 2008, the contents of such applications being incorporated herein by reference.

### BACKGROUND AND FIELD OF THE INVENTION

The invention relates to a micromechanical acceleration sensor, to a method for measuring an acceleration and to the use of the acceleration sensor in motor vehicles.

### SUMMARY OF THE INVENTION

The invention has an object of proposing a micromechanical acceleration sensor and a method for measuring accelerations with which accelerations can be detected relatively precisely.

This object is achieved according to aspects of the invention by means of a micromechanical acceleration sensor comprising at least a first seismic mass which is suspended in a deflectable manner, at least one readout device for detecting the deflection of the first seismic mass and at least one resetting device, and a method for measuring an acceleration having a micromechanical acceleration sensor in which the deflection of at least a first seismic mass is detected by means of at least one readout device, and, in the course of a control method by means of an electronic controller which actuates at least a resetting device, the seismic mass is adjusted to a defined deflection value, in particular the deflection value which corresponds to a position of rest of the seismic mass.

A resetting device is preferably understood to be a capacitive device, in particular acting according to the electrostatic principle, by means of which the deflection of the seismic mass can be influenced and in the process the deflection of the seismic mass is particularly preferably always or continuously re-adjusted to a defined deflection value, wherein this defined deflection value quite particularly preferably corresponds to a position of rest of the seismic mass.

It is preferred that the at least one resetting device comprises at least one electrode, in particular an electrode which is of essentially flat design, and is essentially embodied and arranged relative to the first seismic mass in such a way that there is an essentially quadratic relationship between the deflection of the first seismic mass and/or of the force acting thereon owing to an electrical voltage applied to the resetting device and said electrical voltage. The at least one resetting device particularly preferably comprises one or more plate capacitors and quite particularly preferably does not comprise a meandering capacitor structure which has an essentially linear relationship between the deflection of the first seismic mass owing to an electrical voltage which is applied to the resetting device and this electrical voltage. By virtue of the quadratic relationship described above and the corresponding embodiment of the resetting device it is possible to detect both relatively large and relatively small accelerations relatively precisely since in the region of relatively low accelerations the resetting voltage acceleration characteristic curve is relatively steep and the sensor therefore has a relatively high resolution in this region, and in the region of relatively large accelerations this characteristic curve is relatively flat and therefore there is no need for particularly high resetting voltages for these relatively large accelerations. The acceleration sensor is in particular preferably embodied here in such a way that the resetting voltage acceleration characteristic curve has, at least with respect to the first seismic mass and the at least one resetting device assigned thereto, essentially the profile or the shape of a root function.

The electrode of the at least one resetting device is preferably arranged in an encapsulation module of the acceleration sensor, wherein this encapsulation module is embodied, in particular, as a cover.

The electrode of the at least one resetting device expediently has an angle value of less than 20° with a base surface or substrate plane of the acceleration sensor, and is in particular arranged essentially parallel to the base surface.

It is preferred that the acceleration sensor has at least two readout devices, or a multiple thereof, which are arranged and/or embodied symmetrically with respect to a geometric or mass-related central point and/or a geometric or mass-related central axis of the first seismic mass or of the acceleration sensor.

The acceleration sensor preferably has at least two resetting devices, or a multiple thereof, which are arranged and/or embodied symmetrically with respect to a geometric or mass-related central point and/or a geometric or mass-related central axis of the first seismic mass or of the acceleration sensor.

The at least one resetting device and the at least one readout device preferably have, with the seismic mass assigned thereto, one or more capacitors. This capacitor is in particular embodied as at least one plate capacitor, in particular preferably as comb structures with a plurality of plate capacitors.

It is expedient that the two or more resetting devices and/or readout devices of the acceleration sensor are embodied in such a way that, when at least the first seismic mass is deflected in a first direction, the at least two resetting devices and/or readout devices experience changes in capacitance in opposite directions, that is to say inverse changes in plate spacing with respect to one another. In particular, in this context the comb structures of resetting devices and/or readout devices which are located opposite one another engage one in the other in a manner offset with respect to one another. This opposing formation of capacitances also particularly preferably has otherwise symmetrical resetting devices and/or readout devices as described above.

The first seismic mass is preferably suspended eccentrically with respect to its center of gravity, in particular from at least one torsion spring. When the acceleration sensor is embodied as a single-axis sensor, that is to say for detecting accelerations in one direction, the center of gravity of at least the first seismic mass is particularly preferably embodied displaced in one direction with respect to its suspension axis or torsion axis; in this context, the center of gravity is quite particularly preferably displaced or embodied underneath or above the suspension axis or torsion axis, on a perpendicular with respect to this axis. When the acceleration sensor is embodied as a multi-axis sensor, that is to say for detecting accelerations in at least two different directions, the center of gravity of at least the first seismic mass is particularly preferably embodied displaced in two directions with respect to its suspension axis or torsion axis, and in this context the center of gravity is quite particularly preferably displaced or embodied underneath or above and offset laterally with respect to the suspension axis or torsion axis.

It is expedient that the acceleration sensor be embodied as a three-axis sensor and have four seismic masses which are each suspended from at least one torsion spring, wherein the center of gravity of the seismic mass is displaced in each case with respect to the suspension axis, and in each case two seismic masses are suspended in such a way that the suspension axes are embodied at essentially 90° with respect to the suspension axes of the two other seismic masses. The acceleration sensor comprises, in particular, an electronic evaluation circuit or is connected to such an evaluation circuit which can detect the accelerations in three directions from the deflections and/or resetting voltages of the four seismic masses. The suspension axes are particularly preferably arranged essentially parallel to an x-y substrate plane, wherein the suspension axes of the four seismic masses are oriented in pairs in the x direction and y direction, and quite particularly preferably the suspension axes and/or torsion springs are respectively arranged or embodied here in front of or to the left of the center of gravity of the one respective seismic mass and behind or to the right of the center of gravity of the other respective seismic mass. The seismic masses are each assigned two readout electrodes above and/or underneath, that is to say at a distance in the z direction, with these readout electrodes being assigned or arranged on each side of the suspension axis or of the corresponding torsion spring. As a result of the centers of gravity which are respectively displaced with respect to the respective suspension axis or as a result of the torsion springs which are respectively embodied or arranged eccentrically with respect to the centers of gravity, a pair of seismic masses is deflected in a twisting fashion in antiphase about the y axis when an acceleration acts in the x direction, and the other pair of seismic masses is deflected in a twisting fashion in antiphase about the x axis when an acceleration acts in the y direction. When an acceleration acts in the z direction, that is to say perpendicularly with respect to the substrate plane, all four seismic masses are deflected in a twisting fashion in co-phase about their respective suspension axis.

It is expedient that at least the first seismic mass is assigned at least two readout devices which are assigned and correspondingly arranged with respect to a suspension axis of the first seismic mass on each side of this suspension axis and/or on both sides with respect to this suspension axis and/or which are assigned to a central region of the first seismic mass and are correspondingly arranged, and wherein the at least one resetting device of the first seismic mass is assigned and correspondingly arranged further toward the outside than the readout devices with respect to the suspension axis of said seismic mass and/or the central region. In particular, in each case one resetting device is arranged further toward the outside than the readout device, particularly preferably on both sides of the readout devices. The arrangement of the at least one resetting device in the outer region of the seismic mass has the effect that the required resetting voltage can remain relatively low, that is to say only relatively low electrical resetting voltages are necessary, owing to the relatively large lever with respect to the suspension axis.

The acceleration sensor preferably comprises a control circuit which can adjust the deflection of the seismic mass to a defined deflection value, in particular to the deflection value corresponding to a position of rest of the seismic mass, by means of at least the resetting device.

The at least one readout device preferably detects the deflection of the seismic mass according to the capacitive principle.

It is expedient that the acceleration sensor has at least two readout devices which are both assigned to the seismic mass, as a result of which differential detection of the deflection of the seismic mass can be carried out, and therefore in particular an offset capacitance does not have to be taken into account.

It is preferred that the at least one readout device be arranged above and/or underneath the seismic mass with respect to the substrate plane since there is no need here for additional chip area for readout structures or resetting structures and therefore the sensor can be made smaller.

The acceleration sensor preferably has in each case, in particular in pairs, at least one resetting device or at least one resetting electrode in front of and behind or above and underneath at least the first seismic mass, as a result of which the overall capacitance of the resetting devices is increased, in particular doubled, and therefore relatively low resetting voltages, that is to say an electrical voltage which is applied to the respective resetting device, are necessary.

One advantage of the acceleration sensor with a resetting device/resetting devices is the small design compared to sensors having a plurality of seismic masses which are suspended from springs for various measuring ranges, or compared to a plurality of sensors. A further advantage is that existing sensor designs can be used which only have to be extended with the at least one resetting device.

The measuring range of a low-g sensor (typically 1-5 g) can preferably be extended to an additional higher measuring range (50-100 g) solely through integration of at least one resetting device or additional electrodes. Through a suitable arrangement in a motor vehicle it is therefore possible to dispense with a previously partially customary or previously necessary, separate high-g acceleration sensor.

In particular compared to resetting devices which are embodied as meandering comb structures, at least one resetting device comprising at least one parallel plate capacitor permits non-linear resetting of the seismic mass or of the acceleration signal. This makes it significantly easier to implement the opposing requirements for a resolution which is as high as possible in the low-g range and the largest possible measuring range with the lowest possible resetting voltages in the high-g range. The reduction of the resolution which is normally associated with increasing measuring range only occurs at high accelerations with this solution. The non-linear profile of the transmission characteristic curve therefore ensures that a relatively high resolution can be achieved during measurements in the low-g measuring range (1-5 g).

The method is preferably developed by carrying out the adjustment process continuously.

It is preferred that the acceleration which is detected by the acceleration sensor is calculated at least from the value of an electrical voltage which is applied to the resetting device for adjusting the deflection of the seismic mass to the defined deflection value within the scope of the adjustment process.

The invention also relates to the use of the micromechanical acceleration sensor in motor vehicles, in particular for the combined detection of relatively low accelerations, in particular for ESP applications, and relatively large accelerations, for example for vehicle occupant protection applications and airbag applications.

### BRIEF DESCRIPTION OF THE DRAWINGS

The invention is best understood from the following detailed description when read in connection with the accompanying drawings. Included in the drawings are the following figures:

FIG. 1 shows an exemplary control system for an acceleration sensor in the form of a block diagram, wherein the acceleration sensor comprises a resetting controller and a relatively wide measuring range,

FIG. 2a shows an exemplary embodiment with four resetting devices, and FIG. 2b shows an exemplary acceleration sensor with four readout devices,

FIG. 3 shows an exemplary embodiment with a first seismic mass which has a center of gravity which is displaced with respect to its suspension axis,

FIG. 4 shows an exemplary three-axis acceleration sensor,

FIG. 5 shows a cross section through an exemplary acceleration sensor with two seismic masses 2b, 2c which are deflected in co-phase in the z direction by an acceleration,

FIG. 6 shows a cross section through an exemplary acceleration sensor with electrodes and resetting devices located above and underneath. This reduces the resetting voltage requirement since the capacitance is increased. Likewise, the signal strength of the readout electrodes is larger for the same reason,

FIG. 7 shows an exemplary transmission function of a resetting signal and of a linearized signal as a function of the acceleration, and

FIG. 8 shows an exemplary illustration of the resolution of a reset acceleration sensor as a function of the resetting voltage at the resetting electrodes.

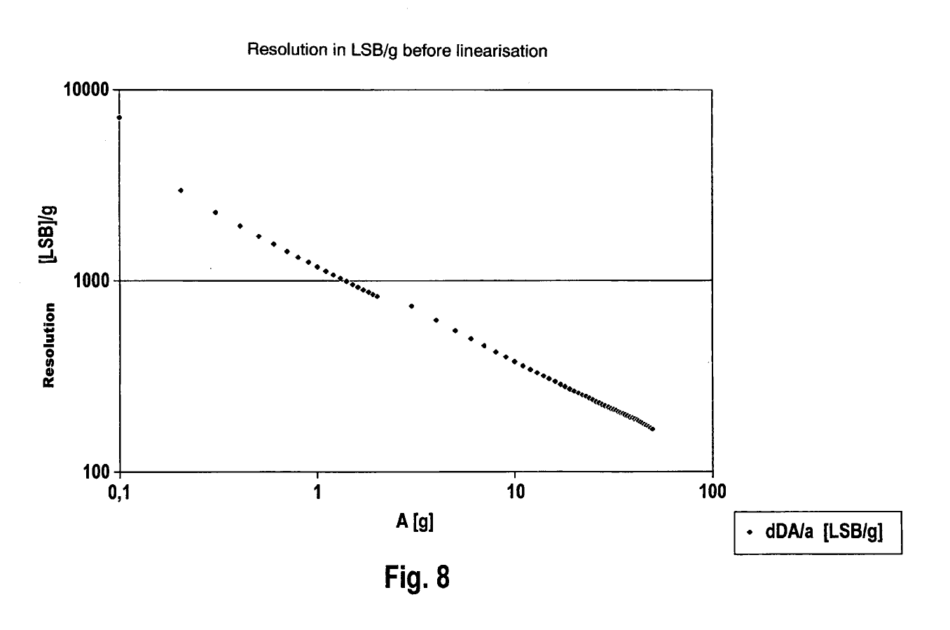

### DETAILED DESCRIPTION OF THE INVENTION

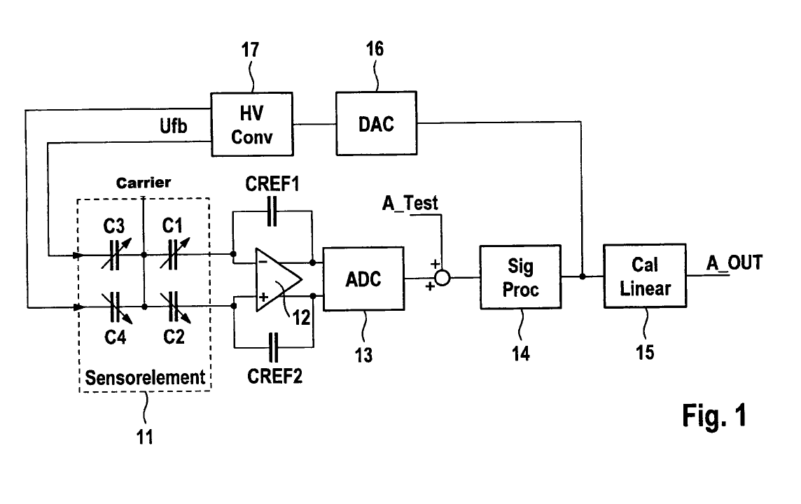

FIG. 1 shows by way of example the functional principle with the circuit components of an electronic controller which is connected to sensor element 1, composed schematically of the measuring capacitors C1 and C2. The deflection of the seismic mass is measured using these capacitors. The arrangement of C1, C2 is selected here such that a deflection of the seismic mass brings about an opposing change in the two capacitors C1 and C2. The conversion of the capacitance signal into an electrical measuring variable is done by feeding in a constant alternating voltage at Pin (carrier). The changes in capacitance at C1, C2 are converted into a proportional voltage signal by means of the subsequent current/voltage transformer composed of the amplifier block 2 and the two reference capacitors CREF1 and CREF2. Circuit block 3 comprises an A/D converter which converts the analog signal into a digital signal. There are a plurality of embodiments for the implementation of the A/D converter. Parallel converters permit direct conversion into a digital bit signal with a predefined conversion range. Further alternative embodiments are embodied, for example, as sigma/delta converters in which the analog signal is firstly converted into a pulse-width-modulated signal and then converted into a parallel digital signal via at least one subsequent decimation stage. Circuit block 4 is composed of a controller structure which sets the output signal in such a way that the input signal is adjusted to 0. This controller has the effect that the voltage signal which is fed back to the resetting electrodes C3, C4 via the D/A converter 7 and the high voltage converter 8 is set in such a way that the force of the acceleration signal acting on the seismic mass is compensated by the electrostatic force acting in C3 and C4. In a similar way to the A/D converter, it is also possible to use a sigma/delta converter here. A combination of the A/D converter with the D/A converter to form what is referred to as a closed-loop signal delta converter is also possible.

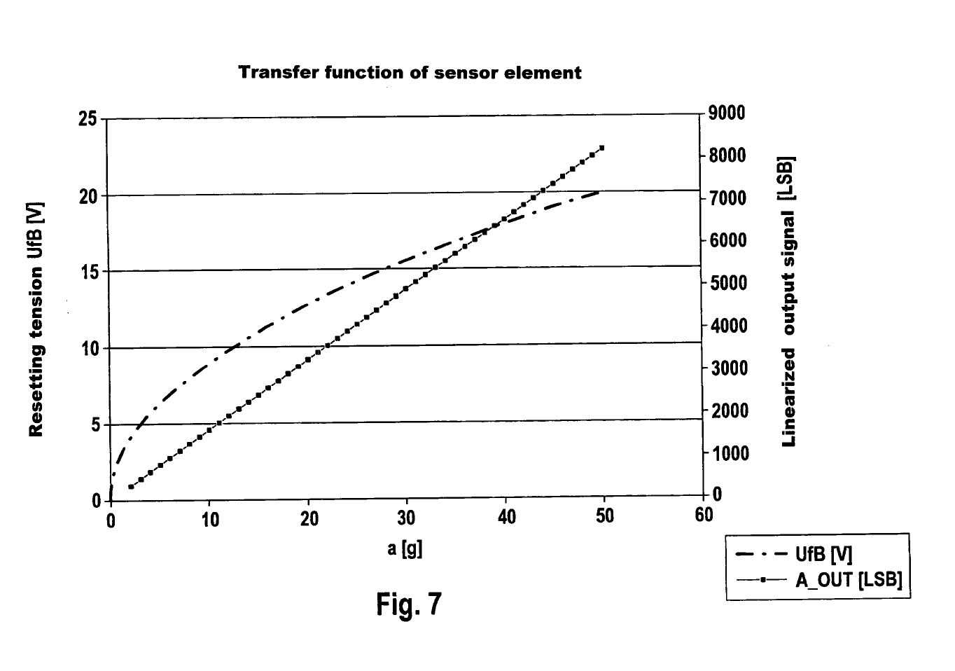

As a result of the relationship which applies to the parallel plate capacitor, according to which the acting electrostatic force is proportional to the square of the acting voltage, the non-linear dependence of the resetting voltage which is illustrated in FIG. 7 on the acting acceleration is produced. In the signal processing block 8, the signal is squared by multiplication and therefore a linear relationship with respect to the acceleration is restored. The adjustment of the offset and of the sensitivity—which is advantageous for sensors of this class of accuracy, then likewise takes place in the signal processing block 8. By means of an additional test input it is possible to deflect the seismic mass by means of electrostatic excitation for testing purposes. It is therefore possible to detect loose particles or etching residues which are possibly present.

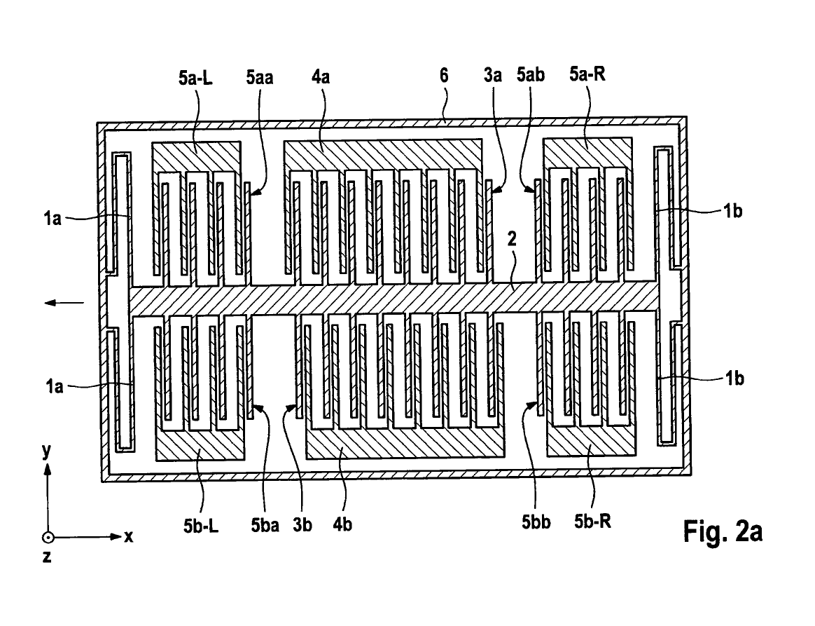

FIG. 2 illustrates an exemplary embodiment of a micromechanical acceleration sensor which comprises a seismic mass 2 which is suspended from a frame by means of springs 1a and 1b, and readout devices 3a, 3b with opposing electrodes 4a, 4b which are attached to the substrate and with which a change in capacitance of these comb structures can be detected differentially. In addition, the acceleration sensor has resetting devices 5aa-5bb with opposing electrodes 5a/b-L and 5a/b-R, respectively, which are embodied as capacitive comb structures and with which it is possible to make available or generate forces which counteract the movement of the seismic mass 2. By applying an electrical voltage, which is in correct phase with respect to the oscillation of the seismic mass 2, to 5a/b-L and 5a/b-R, respectively, it is possible to compensate an acting force, in particular a force which is caused by a detected acceleration. The four resetting devices 5aa to 5bb are arranged symmetrically with respect to the central point of the seismic mass 2. The reading out of signals is carried out, for example, in a doubled differential fashion by means of the two readout devices 3a and 3b, which are embodied and arranged symmetrically with respect to the central axis of the seismic mass 2 in the x direction, but the comb structures engage in an offset or opposing fashion one in the other, as a result of which, when the seismic mass 2 is deflected in the negative x direction, illustrated by way of example by the arrow, the comb structures of the readout device 3a, 4a experience a positive change in the capacitance, and the comb structures of the readout device 3b, 4b experience a negative change in capacitance.

FIG. 2b illustrates an exemplary embodiment with four readout devices 3a-3d, 4a-4d which are arranged symmetrically at the central point of the seismic mass 2, but here they each have comb structures which engage one in the other in pairs in an opposing or offset fashion, which additionally permits differential measurement. The changes in capacitance c− and c+ of these comb structures when the seismic mass 2 is deflected in the direction indicated by the arrow are also illustrated. Four schematically indicated resetting devices 5aa to 5bb are arranged in the outer region.

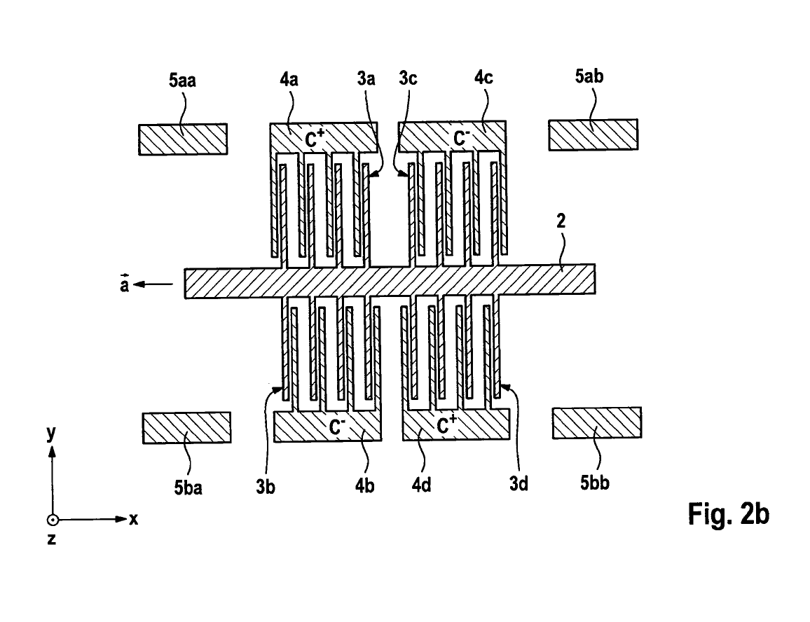

FIG. 3 shows a cross section through an exemplary micromechanical acceleration sensor comprising a seismic mass 2 with a center of gravity which is displaced with respect to the springs 1, a frame 6, readout devices 4a, 4b and additional resetting devices 5-L, 5-R which are embodied as electrodes. The acceleration sensor is closed off by means of a cover or encapsulation module 7 which has electrical vias 8 with which the electrodes can be connected.

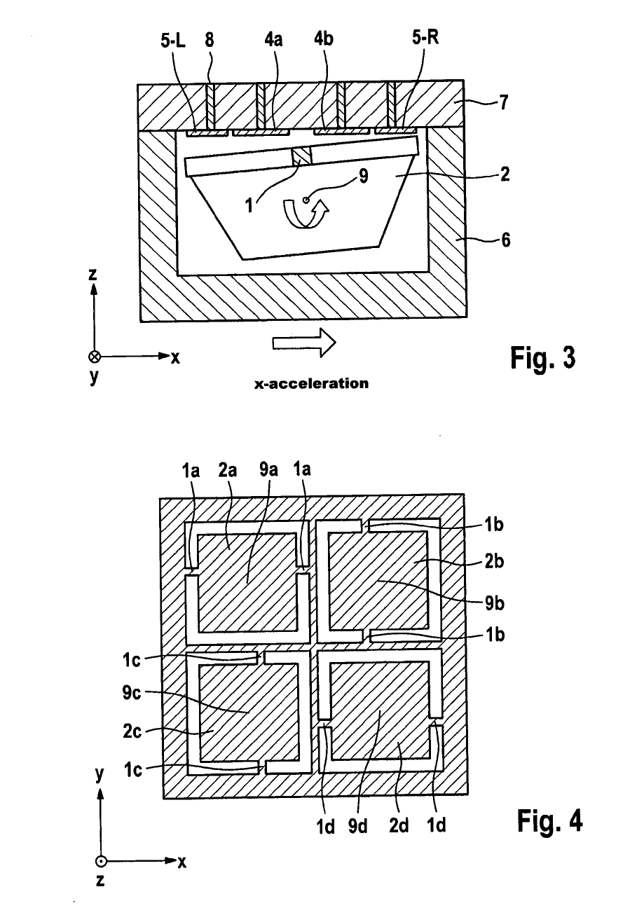

FIG. 4 illustrates an exemplary three-axis acceleration sensor with four seismic masses 2a-d, with spring suspensions or torsion springs 1a-d which are displaced with respect to the center of gravity of the masses 9a-d. Of the four seismic masses 2a-2d, in each case two seismic masses 2b, 2c are suspended in such a way that the suspension axes are oriented at essentially 90° with respect to the suspension axes of the two other seismic masses 2a, 2d. The acceleration sensor comprises, in particular, an electronic evaluation circuit (not illustrated) or is connected to such an evaluation circuit which can detect the accelerations in three directions from the deflections and/or resetting voltages of the four seismic masses 2a to 2d. The suspension axes are particularly preferably arranged essentially parallel to an x-y substrate plane, wherein the suspension axes of the four seismic masses are oriented in pairs in the x direction 1a, 1d and y direction 1b, 1c and the suspension axes of the center of gravity 9a-9d of the respective seismic mass are respectively arranged or embodied here in front of the one respective seismic mass 1d or to the left of the one respective seismic mass 1b and behind the other seismic mass 1a or to the right of the other seismic mass 1c. The seismic masses are each assigned two readout electrodes (not illustrated) above and/or underneath, that is to say at a distance in the z direction, wherein these readout electrodes are assigned on both sides of the suspension axis or the corresponding torsion spring. As a result of the centers of gravity which are respectively displaced with respect to the respective suspension axis or as a result of the torsion springs which are respectively embodied or arranged eccentrically with respect to the centers of gravity, a pair of seismic masses is deflected in a twisting fashion in antiphase about the y axis when an acceleration acts in the x direction, and the other pair of seismic masses is deflected in a twisting fashion in antiphase about the x axis when an acceleration acts in the y direction. When an acceleration acts in the z direction, that is to say perpendicularly with respect to the substrate plane, all four seismic masses are deflected in a twisting fashion in co-phase about their respective suspension axis.

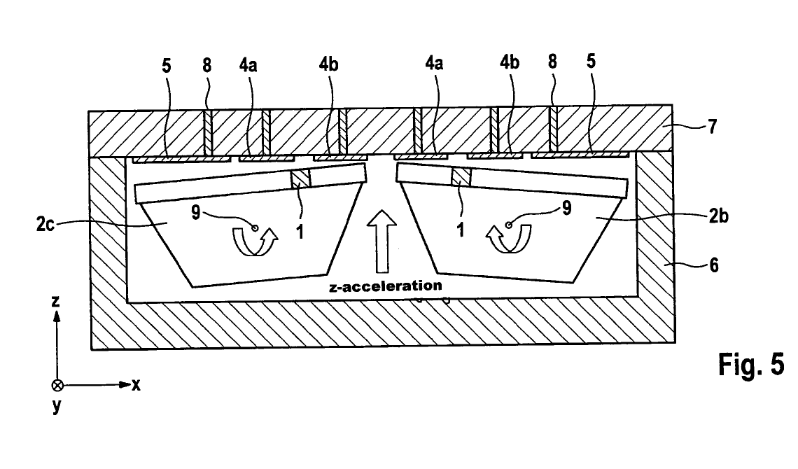

FIG. 5 shows an exemplary embodiment in which the seismic masses 2b and 2c, which are each suspended eccentrically with respect to their center of gravity 9 by means of torsion springs 1, are assigned two readout devices 4a and 4b which are arranged on both sides of the suspension axis above the seismic mass 2b, 2c in a central region of these masses. In each case a resetting device 5 is assigned to the seismic masses and arranged further toward the outside. The arrangement of the resetting devices 5 in the outer region of the seismic masses 2b, 2c has the effect that the required resetting voltage can remain relatively low, that is to say only relatively low electrical resetting voltages are necessary, owing to the relatively large lever with respect to the suspension axis.

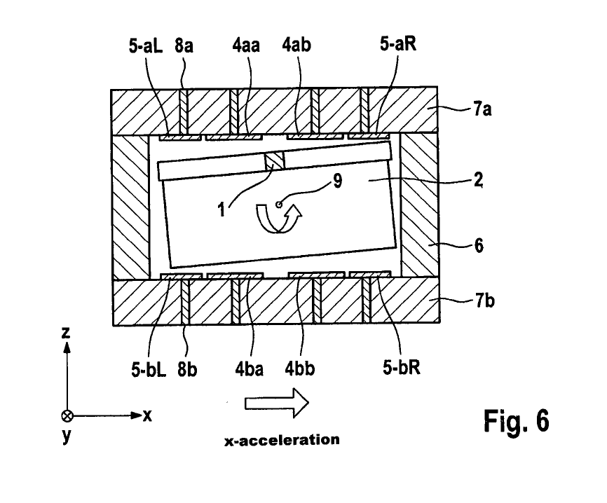

FIG. 6 shows an exemplary cross section of an acceleration sensor with a seismic mass 2 which is suspended eccentrically with respect to its center of gravity from torsion spring 1. The seismic mass 2 is respectively assigned readout devices 4aa, 4ab above the suspension axis or torsion spring 1 on each side and readout devices 4ba, 4bb underneath the suspension axis or torsion spring 1 on each side, with respect to the z direction and perpendicularly with respect to the x-y substrate plane. Resetting devices 5 are likewise assigned and correspondingly arranged on both sides with respect to the readout devices, in an outer region above and underneath the seismic mass 2. Electrical contact is formed between said resetting devices 5 by means of vias 8a, 8b in the encapsulation modules or covers 7a, 7b.

1-10. (canceled)

11. A micromechanical acceleration sensor comprising:
at least a first seismic mass which is suspended in a deflectable manner,
at least one readout device for detecting a deflection of the first seismic mass, and
at least one resetting device.

12. The acceleration sensor as claimed in claim 11, wherein the at least one resetting device comprises at least one electrode and is substantially embodied and arranged relative to the first seismic mass in such a way that there is a substantially quadratic relationship between the deflection of the first seismic mass owing to an electrical voltage applied to the resetting device and said electrical voltage.

13. The acceleration sensor as claimed in claim 12, wherein the electrode is substantially flat.

14. The acceleration sensor as claimed in claim 11, wherein the acceleration sensor has at least two readout devices, or a multiple thereof, which are arranged symmetrically with respect to a geometric or mass-related central point and/or a geometric or mass-related central axis of the first seismic mass or of the acceleration sensor.

15. The acceleration sensor as claimed in claim 11, wherein the acceleration sensor has at least two resetting devices, or a multiple thereof, which are arranged symmetrically with respect to a geometric or mass-related central point and/or a geometric or mass-related central axis of the first seismic mass or of the acceleration sensor.

16. The acceleration sensor as claimed in claim 11, wherein the acceleration sensor comprises a control circuit which adjusts at least the deflection of the first seismic mass to a defined deflection value by means of at least the resetting device.

17. The acceleration sensor as claimed in claim 16, wherein the deflection value corresponds to a position of rest of the first seismic mass.

18. The acceleration sensor as claimed in claim 11, wherein at least the first seismic mass is suspended eccentrically with respect to its center of gravity.

19. The acceleration sensor as claimed in claim 11, wherein at least the first seismic mass is suspended eccentrically from at least one torsion spring.

20. The acceleration sensor as claimed in claim 11, wherein at least the first seismic mass is assigned at least two readout devices which are assigned and correspondingly arranged with respect to a suspension axis of the first seismic mass on each side of the suspension axis and/or on both sides with respect to the suspension axis and/or which are assigned to a central region of the first seismic mass and are correspondingly arranged, and wherein the at least one resetting device of the first seismic mass is assigned and correspondingly arranged further toward the outside than the readout devices with respect to the suspension axis of said seismic mass and/or the central region.

21. A method for measuring an acceleration having a micromechanical acceleration sensor as claimed in claim 11 comprising the steps of:
detecting the deflection of at least a first seismic mass by means of at least one readout device, and
adjusting the seismic mass to a defined deflection value in the course of a control method by an electronic controller which actuates at least a resetting device.

22. The method of claim 21, wherein the deflection value corresponds to a position of rest of the seismic mass.

23. The method as claimed in claim 21, wherein the acceleration which is detected by the acceleration sensor is calculated at least from the value of an electrical voltage which is applied to the resetting device for controlling the deflection of the first seismic mass to the defined value within the scope of said adjusting step.

24. The use of the micromechanical acceleration sensor as claimed in claim 11 in motor vehicles.
